(19) United States
(12) Patent Application Publication
(10) Pub. No.: US 2018/0265618 A1
(43) Pub. Date: Sep. 20, 2018

(54) METHOD FOR PRODUCING A RIGID POLYURETHANE-POLYISOCYANURATE FOAM

(71) Applicant: Covestro Deutschland AG, Leverkusen (DE)

(72) Inventors: Hans-Detlef Arntz, Overath (DE); Reinhard Albers, Leverkusen (DE); Patrick Klasen, Vettweiss (DE); Ernst Felske, Neuss (DE)

(73) Assignee: Covestro Deutschland AG, Leverkusen (DE)

(21) Appl. No.: 15/759,930

(22) PCT Filed: Sep. 15, 2016
(86) PCT No.: PCT/EP2016/071877

§ 371 Date: Mar. 14, 2018

(30) Foreign Application Priority Data
Sep. 18, 2015 (EP) 15185790.1

(51) Int. Cl. C08G 18/02; C08G 18/18; C08G 18/48; C08G 18/61; C08G 18/76; B32B 5/18; B32B 1/08; F16L 59/14

(52) U.S. Cl. CPC C08G 18/022; C08G 18/1825; C08G 18/4825; C08G 18/4829; C08G 2101/0025; C08G 18/7671; B32B 5/18; B32B 1/08; F16L 59/14; C08G 18/61

(57) ABSTRACT

The invention relates to a method for producing rigid polyurethane-polyisocyanurate (PUR/PIR) foams using partially trimerized isocyanate blends. The invention further relates to the rigid polyurethane-polyisocyanurate foams obtainable by said method and to the use thereof in manufacturing composite elements made of the rigid polyurethane-polyisocyanurate foams and suitable coatings. The invention also relates to the composite elements obtainable thereby.

The present invention relates to a method for producing rigid polyurethane-polyisocyanurate (PUR-PIR) foams by using partially trimerized isocyanate blends. The present invention further relates to the rigid polyurethane-polyisocyanurate foams thus obtainable and to their use in the manufacture of composite elements combining the rigid polyurethane-polyisocyanurate foams and suitable facing layers. The composite elements thus obtainable are a further part of the subject matter of the invention.

Rigid PUR-PIR foams are typically produced using at least one catalyst by reacting a polyol component with an isocyanate component in the presence of a blowing agent. Additives such as foam stabilizers and flame retardants may further also be added.

Rigid PUR-PIR foams have excellent thermal stability and improved fire properties as compared with other rigid foams such as rigid polyurethane (PUR) foams for example These improved properties are ascribed to isocyanurate structural elements.

Catalysts used are frequently carboxylate salts such as, for example, alkali metal carboxylates. However, their use often leads to processing problems which can lead to severe difficulties in both continuous foaming facilities and in batch processes. These processing problems are ultimately attributable to the fact that the onset temperature for urethane group formation is lower than that for isocyanurate group formation. At the beginning of the urethanization reaction, the reaction mixture heats up as a result of the exothermic nature of the reaction. The trimerization reaction (formation of isocyanurate groups) ensues on attainment of a certain temperature, generally from the order of 60° C.

A plot of the height of rise of the foam versus time in such cases shows a bimodal (2-stage) reaction profile, i.e., the rate of rise passes through two maxima: the first maximum corresponds to the onset of the urethanization reaction and the second to that of the trimerization reaction. So the foam ultimately expands at two different rates during the foaming process. Properties can suffer as a result.

Rigid PUR-PIR foams are generally applied to firm supports, e.g., metallic facing layers. One possible effect of a bimodal reaction profile in this process is that the bond between the foam and the supporting material is severely disrupted, which in some instances can lead all the way to the foam tearing off from the support. In the case of foamed articles in rigid PUR-PIR foam, such a bimodal reaction and rise profile can lead to foam back-flow at the end of the flow path of the flowing foam, causing voiding and air entrapments. Neither is desirable because of the adverse effects on the properties of the foamed article, for example the insulating performance, the adherence between the foam and the support and the visual surface quality (as in the case of metal-faced composite elements for example).

To solve this problem, EP 1 878 493 A1 proposes the use of specific carbanionic catalysts. These carbanionic catalysts can be described by the general formula

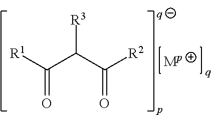

where R¹ to R³, M, p and q are each as defined in paragraph [0006] of said document. The catalysts in question accordingly have an acetylacetonato-carbanion unit. The disadvantage with this method is the high cost of carbanionic catalysts, as compared with the catalysts otherwise customary in the prior art, and also the limited commercial availability of carbanionic catalysts.

WO 2013/024107 A describes the use in rigid PUR-PIR foams of polyester polyols having secondary hydroxyl end groups, which are obtainable by addition reaction of epoxides onto acid-terminated polyesters. This therein described two-stage manufacturing process is costly and inconvenient.

WO 2009/039332 A describes a method for producing isocyanurate-containing isocyanate blends wherein a polymeric MDI having a viscosity between 30 and 300 mPas and a polymeric MDI comprising isocyanurate groups (pMDI) is reacted to afford a liquid product having a viscosity of 400-20000 mPas, which is stated to be suitable for various polyurethane applications, for example for foams having improved compressive strength. The viscosity is described as comparable to that of pMDIs obtained as bottom product following monomer removal. However, the products obtained by the method described in WO 2009/039332 A are low in 4,4′-diphenylmethane diisocyanate and therefore exhibit weaker rigidification and an increased open-cell content, this being disadvantageous for the manufacture of insulating materials.

EP 0118725 A3 lays claim to isocyanurate-modified polyisocyanate mixtures of monomeric diphenylmethane diisocyanates having an isocyanate content of 23 to 31 wt %, obtained by partial trimerization of a mixture consisting of 80 to 30 wt %, based on the total weight, of 4,4′-diphenylmethane diisocyanate and 20 to 70 wt %, based on the total weight, of 2,4′-diphenylmethane diisocyanate in the presence of a trimerization catalyst and, optionally, subsequent deactivation of the trimerization catalyst. This method leads to o-NCO-enriched isocyanate blends, based on monomeric MDIs, the reactivity of which is limited by steric hindrance and the consolidation behavior of which in the course of conversion into polyurethane is distinctly slowed by the lower functionality.

EP 0 472 063 A lays claim to isocyanurate-modified polyisocyanate mixtures having an NCO content of 15-30 wt %, obtainable by partial trimerization of a mixture comprising 80-100 wt % of monomeric diphenylmethane diisocyanates consisting of 80 to 40 wt %, based on the total weight, of 4,4′-diphenylmethane diisocyanate and 20 to 60 wt %, based on the total weight of the monomeric MDI, of 2,4′-diphenylmethane diisocyanate and also 0-8 wt % of 2,2′-diphenylmethane diisocyanate in the presence of a trimerization catalyst and, optionally, subsequent deactivation of the trimerization catalyst. The use of isocyanates comprising at least 16 wt % of 2,4′-diphenylmethane diisocyanates likewise leads to o-NCO-enriched polyisocyanate mixtures whose reactivity is limited by the steric hindrance. Foam rigidity is also adversely affected.

U.S. Pat. No. 4,743,627 A presents a method for producing a stable isocyanurate-modified pMDI wherein initially the pMDI is trimerized in the presence of a trimerization catalyst such that the viscosity is between 5000 and 200 000 mPas at 25° C. and then, following deactivation of the catalyst, the polymeric MDI is mixed with methylenebis(phenyl isocyanate)s (two-ring component) to obtain isocyanate blends in the customary viscosity range from 150 to 2000 mPas, while the two-ring content of the resulting blends is to be at least 60 wt % of the overall ring content. There is an express statement that stable isocyanate products cannot be obtained by preblending the two-ring component and pMDI and then trimerizing, and this even if a mixture of 4,4′-MDI and 2,4′-MDI is used as two-ring component, from each of which generally more stable isocyanate blends can be formed by virtue of the reduced tendency to crystallize. Unstable isocyanate blends in turn are not marketable for polyurethane applications.

On the basis of the prior art recounted above (EP 1 878 493 A1, EP 0 472 063 A, WO 2013/024107 A), there continues to be a need for a method of producing rigid PUR-PIR foams in a unitary reaction profile without using specific polyesters or catalysts. Neither in WO 2009/039332 A, EP 0118725 A, EP 0 472 063 A nor in U.S. Pat. No. 4,743,627 A is there any recognition and disclosure that such a method is available by pretrimerizing a suitable selection of isocyanates.

“Monomeric MDI” (mMDI) herein is to be understood as meaning a polyisocyanate mixture consisting of one or more compounds selected from 4,4′-diphenylmethane diisocyanate, 2,4′-diphenylmethane diisocyanate and 2,2′-diphenylmethane diisocyanate.

“Oligomeric MDI” herein is to be understood as meaning a polyisocyanate mixture consisting of comparatively high-nuclear homologs of MDI which have at least 3 aromatic nuclei and a functionality of at least 3.

“Polymeric MDI” (pMDI) herein is to be understood as meaning a mixture comprising oligomeric MDI and optionally monomeric MDI. The monomer content of a polymeric MDI is typically in the range of 30-50 wt %, based on the total mass of the pMDI.

The present inventors, then, found that surprisingly (and in contradistinction to U.S. Pat. No. 4,743,627 A) the disadvantages associated with the prior art methods are overcome by a method of producing a rigid PUR-PIR foam (hereinafter also referred to as “foaming”) by reacting a PUR-PIR system comprising
1) an isocyanate component A comprising
   1.1)15-25 wt %, preferably 18-25 wt % of isocyanurate groups and
   1.2)30-55 wt %, preferably 35-45 wt % of monomeric MDI,
   1.3) an NCO content of 23-30 wt % (EN ISO 11909:2007), all based on the total weight of the isocyanate component, and
2) a polyol formulation (B)
   in the presence of
3) blowing agents (C),
4) catalysts (D), and
5) optionally further auxiliary and added-substance materials (E)

wherein the isocyanate component A is obtained by a method comprising the steps of
(i) preparing an isocyanate blend A2 by partially trimerizing an isocyanate mixture A1 comprising oligomeric and monomeric MDI, wherein A1 prior to trimerization has
   a total monomeric MDI content of 55-80 wt %, preferably of ≥55 to <80 wt %, more preferably of ≥58-≤78 wt % (based on the total weight of A1) and
   a viscosity of <30 mPas, preferably <28 mPas and more preferably <27 mPas at 25° C. (DIN EN ISO 3219:1994); and
(ii) optionally then blending the partially trimerized isocyanate blend A2 obtained in step (i) with further isocyanates (A3), preferably polymeric MDI,

and wherein the system comprising the components A-E has an isocyanate index of 90 to 150, preferably 100 to 140 and more preferably 110 to 130.

The rigid PUR-PIR foams thus obtainable, which are likewise a part of the subject matter of the present invention, have higher glass transition temperatures and lower thermal conductivities than the prior art foams. Yet at the same time the foams do not have the disadvantages of a bimodal reaction kinetics that are found in PUR-PIR processing.

The present invention further provides a method wherein the foaming process takes place against at least one facing layer to obtain a composite element comprising at least one facing layer and the rigid PUR-PIR foam of the present invention, and the composite elements, in particular insulated pipes, thus obtainable.

Since the isocyanurate structures are already part of the isocyanate component A and are not first formed in the course of the foaming process, the aforementioned disadvantages due to the bimodal reaction kinetics (poor adherence to facing layers, inadequate quality of surface finish) are foreclosed.

Where a measurement procedure is needed to determine the characteristic values referred to in this description and is not directly stated, the measurement procedure referred to and/or described in the example part is referenced.

Rigid PUR-PIR foams within the meaning of the present invention are particularly those PUR-PIR foams whose apparent density as per DIN EN ISO 3386-1-98 as at September 2010 is in the range from 15 kg/m³ to 300 kg/m³ and whose compressive strength as per DIN EN 826 as of May 1996 is in the range from 0.1 MPa to 3 MPa.

The A1 isocyanate mixture to be used has a total monomeric MDI content of 55-80 wt %, preferably of ≥55 to <80 wt %, more preferably of ≥58-≤78 wt % (based on the total weight of A1) and a viscosity of <30 mPas, preferably <28 mPas and more preferably <27 mPas at 25° C. (DIN EN ISO 3219:1994).

The A1 isocyanate mixture to be used preferably has an oligomeric MDI content of 20-35 wt %. The presence of oligomeric MDI enhances the solubility of the trimer.

Isocyanate mixture A1, which is used as starting mixture for the trimerization reaction (i), is preferably obtained by enriching a commercially available polymeric MDI with 4,4′-MDI and/or an isomeric mixture of TDI (2,4-tolylene diisocyanate, 2,6-tolylene diisocyanate, mixtures of 2,4- and 2,6-tolylene diisocyanates). Enrichment with purely 4,4′-MDI is preferable.

The isocyanate mixture A1 comprises with preference 50-80 wt % and with particular preference 65-78 wt % (based on the total weight of A1) of 4,4′-MDI. This influences the reactivity of the resulting isocyanate blend in a favorable manner, the enrichment with 4,4′-MDI versus products having a higher 2,4′-MDI content leading to a faster rigidification in the foam. Further (poly)isocyanates may be present in A1 at low fractions (preferably <20 wt %, more preferably <10 wt % and most preferably <5 wt %, based on the total weight of A1). The usual aliphatic, cycloaliphatic, araliphatic di- and/or polyisocyanates and especially aromatic isocyanates that are known from polyurethane chemistry come into consideration for this, if at all.

The isocyanate mixture A1 is subjected to a trimerization reaction [step (i)]. The trimerization reaction is known per se and has for example been described in WO 2009/039332 A, [00015]-[00021], incorporated herein by reference. 2,4,6-Tris(dimethylaminomethyl)phenol is an example of a preferably used trimerization catalyst.

The level of isocyanurate groups (in weight percent) in the isocyanate blend obtained following the trimerization reaction (hereinafter referred to as “isocyanate blend A2” or “A2”) is determined as follows:

isocyanurate % (A2)=(NCO % (A1)−NCO % (A2))/(NCO% (A1)/2)*100

The weight fraction of NCO groups is determined as per EN ISO 11909:2007.

Isocyanate component A is optionally obtainable by blending the isocyanate blend A2 with further isocyanates A3. Useful isocyanates A3 include the usual aliphatic, cycloaliphatic, araliphatic di-and/or polyisocyanates and especially aromatic isocyanates that are known from polyurethane chemistry. Aromatic isocyanates, especially the homologs and isomers of the MDI series and also TDI are particularly preferable. Useful isocyanates A3 for blending further include polyurethane prepolymers and/or modified isocyanates. The term “polyurethane prepolymer” refers particularly to reactive intermediates in the reaction of isocyanates to afford polyurethane polymers. They are obtained by reacting a polyol component with an excess isocyanate component. Preferred modified isocyanates include: urea-modified isocyanates; biuret-modified isocyanates; urethane-modified isocyanates; isocyanurate-modified isocyanates; allophanate-modified isocyanates; carbodiimide-modified isocyanates; uretdione-modified isocyanates; and uretonimine-modified isocyanates. Modified isocyanates of this type are commercially available and are obtained by reacting an isocyanate with a substoichiometric amount of an isocyanate-reactive compound or with itself

The monomeric MDI [1.2)] in the isocyanate component A comprises at least 80 wt % of 4,4′-MDI, more preferably at least 90 wt % of 4,4′-diphenylmethane diisocyanate (4,4′-MDI) (weight particulars are based on the total weight of the monomeric MDI).

The polyols used for the polyol formulation B are preferably compounds based on polyesterols or polyetherols. The functionality of the polyetherols and/or polyesterols is generally in the range from 1.9 to 8, preferably in the range from 2.4 to 7 and more preferably in the range from 2.9 to 6.

The polyols have a hydroxyl number of greater than 70 mg KOH/g, preferably greater than 100 mg KOH/g, more preferably greater than 120 mg KOH/g. The upper limit of the hydroxyl number is generally 1000 mg KOH/g, preferably 900 mg KOH/g, particularly 800 mg KOH/g. The OH numbers indicated above are for the entirety of the polyols in the polyol formulation B and do not exclude the possibility that individual constituents of the mixture have higher or lower values.

The polyol formulation B preferably comprises polyether polyols obtained by known methods, for example by anionic polymerization with alkali metal hydroxides, such as sodium hydroxide or potassium hydroxide or alkali metal alkoxides, such as sodium methoxide, sodium ethoxide, potassium ethoxide or potassium isopropoxide as catalysts and by adding at least one starter molecule comprising from 2 to 8, preferably from 3 to 8, reactive hydrogen atoms in attached form, or by cationic polymerization with Lewis acids, such as antimony pentachloride, boron fluoride etherate and so on or fuller's earth as catalysts from one or more alkylene oxides having 2 to 4 carbon atoms in the alkylene moiety. Suitable alkylene oxides include, for example, tetrahydrofuran, 1,3-propylene oxide, 1,2-butylene oxide, 2,3-butylene oxide, styrene oxide and preferably ethylene oxide and 1,2-propylene oxide. The alkylene oxides may be used singly, alternatingly in succession or as mixtures. Useful starter molecules include alcohols, for example glycerol, trimethylolpropane (TMP), pentaerythritol, sucrose, sorbitol, and also amines, for example methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and the like. Useful starter molecules further include condensation products formed from formaldehyde, phenol and diethanolamine/ethanolamine, formaldehyde, alkylphenols and diethanolamine/ethanolamine, formaldehyde, bisphenol A and diethanolamine/ethanolamine, formaldehyde, aniline and diethanolamine/ethanolamine, formaldehyde, cresol and diethanolamine/ethanolamine, formaldehyde, toluidine and diethanolamine/ethanolamine, and also formaldehyde, toluenediamine (TDA) and diethanolamine/ethanolamine and the like. Preference for use as starter molecule is given to TMP and TDA.

The use of catalysts D in the production of rigid PUR-PIR foams is optional. Compounds typically used as catalysts D hasten the reaction of the hydroxyl-containing compounds as components B with the isocyanate groups of component A.

Preference is given to using organotin compounds, such as tin(II) salts of organic carboxylic acids, and/or basic amine compounds, preferably tertiary amines, for example trimethylamine, and/or 1,4-diazabicyclo(2,2, 2)octane. The catalysts are generally used in an amount of 0.001 to 5 wt %, especially of 0.05 to 2.5 wt % of catalyst, based on the weight of component B.

The rigid PUR-PIR foams are further produced using chemical and/or physical blowing agents C.

Preferred chemical blowing agents are water or carboxylic acids, especially formic acid as chemical blowing agent. The chemical blowing agent is generally used in an amount of 0.1 to 5 wt % and especially of 1.0 to 3.0 wt %, based on the weight of component B.

Physical blowing agents are compounds which, dissolved or emulsified in the materials used to make a polyurethane, vaporize under the conditions of polyurethane formation. They are, for example, hydrocarbons, halogenated hydrocarbons, and other compounds, for example perfluorinated alkanes, such as perfluorohexane, hydrochlorofluorocarbons, and also ethers, esters, ketones and/or acetals. These are typically used in an amount of 1 to 30 wt %, preferably 2 to 25 wt %, more preferably 3 to 20 wt %, based on the total weight of component B.

In one preferred embodiment, the polyol formulation B comprises a further constituent in the form of crosslinkers. Crosslinkers are compounds having a molecular weight of 60 to less than 400 g/mol and at least 3 isocyanate-reactive hydrogen atoms. Glycerol is one example thereof. The crosslinkers are generally used in an amount of 1 to 10 wt %, preferably of 2 to 6 wt %, based on the total weight of polyol formation B (minus physical blowing agents).

In a further preferred embodiment, the polyol formulation B comprises chain-extending agents, used to enhance the crosslink density. Chain-extending agents are compounds having a molecular weight of 60 to less than 400 g/mol and 2 isocyanate-reactive hydrogen atoms. Examples thereof are butanediol, diethylene glycol, dipropylene glycol and also ethylene glycol. The chain-extending agents are generally used in an amount of 2 to 20 wt %, preferably of 4 to 15 wt %, based on the total weight of polyol formulation B (minus physical blowing agents).

Crosslinkers and chain-extending agents are usable in the polyol mixture in single or combined form.

The polyurethane foams of the present invention are obtainable by reacting the polyurethane system of the present invention. The reaction generally makes the isocyanate component A and the polyol formulation B react with each other in such amounts that the isocyanate index of the foam is in the range from 90 to 150, preferably from 100 to 140 and more preferably from 110 to 130.

The isocyanate index (or else just index) is the quotient formed by dividing the actually used amount-of-substance [in moles] of isocyanate groups by the amount-of-substance [in moles] of isocyanate groups which is stoichiometrically needed for complete conversion of all isocyanate-reactive groups and multiplying by 100. Since the reaction of one mole of an isocyanate-reactive group requires one mole of an isocyanate group, the following equation holds:

index=(moles of isocyanate groups/moles of isocyanate-reactive groups)*100

In one preferred embodiment, components A and B of the polyurethane system are chosen such that the resulting foam has a compressive strength (at an apparent density of 60 kg/m³) of above 0.2 N/mm², preferably above 0.25 N/mm², more preferably above 0.3 N/mm², as measured to DIN 53421:1984-06.

The reaction mixture may optionally also incorporate yet further auxiliary and added-substance materials (E). They are to be understood as the auxiliary and added-substance materials which are known and customary in the prior art. Examples are surface-active substances, foam stabilizers, cell regulators, fillers, dyes, pigments, flame retardants, antistats, hydrolysis control agents and/or fungistatically and bacteriostatically acting substances.

The PUR-PIR systems of the present invention find preferential use in the manufacture of composite elements. Here the foaming process typically takes place in a continuous or batch manner against at least one facing layer.

The present invention accordingly further provides the method of using a rigid PUR-PIR foam of the present invention as insulation foam and/or as adhesion promoter in composite elements, wherein the composite elements combine a layer comprising a rigid PUR-PIR foam of the present invention and a facing layer. This facing layer is at least partly contacted by the layer comprising the rigid PUR-/PIR foam of the present invention. The material of the facing layer is typically aluminum, steel, bitumen, paper, a mineral nonwoven, a nonwoven comprising organic fibers, a polymeric panel, a polymeric film/sheet, and/or a wooden panel.

The PUR-PIR systems of the present invention are particularly useful in the manufacture of insulated pipes, for example district heating pipes. The present invention thus also provides the method of using the polyurethane system of the present invention in the manufacture of insulated pipes.

In one preferred embodiment, the polyurethane system of the present invention is used in the manufacture of insulated composite jacketed pipes for buried district heating grids as per DIN EN 253.

The present invention further provides an insulated pipe constructed of

a) a media pipe

b) a layer of insulating material comprising the rigid PUR-PIR foam of the present invention, and

c) a jacketing pipe.

The media pipe (a) comprises in general a steel pipe having an outer diameter of 1 to 120 cm, preferably 4 to 110 cm and a length of 1 to 24 meters, preferably 6 to 16 meters. On its outer surface, the media pipe has a layer of insulating material b) comprising the polyurethane foam of the present invention. This layer is generally from 1 to 10 cm and preferably 2 to 5 cm in thickness. In one preferred embodiment, the layer of insulating material has an overall apparent density of below 90 kg/m³, preferably of 70 to 87 kg/m³ (DIN EN ISO 845:2009).

Overall apparent density here refers to the apparent density distribution across the pipe cross section and the pipe length. In a further preferred embodiment, the layer of insulating material (b), comprising the polyurethane foam of the present invention, has a thermal conductivity of less than 27 mW/mK, preferably of 22 to 26.9, as measured to DIN EN ISO 52616:1977. The jacketing pipe (c) surrounds the layer of insulating material and consists generally of polymer, for example of polyethylene, and typically is from 1 to 30 mm in thickness. The inner diameter of the jacketing pipe is generally from 6 to 140 cm, preferably 10 to 120 cm.

The jacketing pipe (c) may optionally consist of two or more layers which are merged in the course of the extrusion process. One example thereof is the importation of multi-ply foils between the PUR foam and the PE jacket, said foil comprising at least one metallic ply to improve the blocking effect. Suitable jacketing pipes of this type are described in EP-A-960 723.

The invention finally provides a method of producing the insulated pipes of the present invention, which comprises the steps of:

1) providing the media pipe and the jacketing pipe, wherein the media pipe is positioned within the jacketing pipe, using spacers for example,

2) filling polyurethane system of the present invention into the space between the media pipe and the jacketing pipe,

3) foaming and curing the polyurethane reaction mixture.

One embodiment comprises producing the pipes in a batch method. In this method, the media pipe (generally steel) is provided star-shaped spacers to center the inner pipe. The media pipe is pushed into the outer jacketing pipe (generally polyethylene), resulting in an annular gap between the two pipes. This annular gap is by virtue of its good insulating properties filled with polyurethane foam. To this end, the duopipe slightly inclined, preferably inclined at an angle of 1° to 10°, preferably 1.5° to 7°, typically by means of an inclinable foaming table, is provided closure caps endowed with venting holes.

### EXAMPLES

Starting Materials:

MDI-1: Desmodur® 44V20 polymeric MDI from Bayer MaterialScience AG, viscosity at 25° C. is 200 +/−40 mPas at an NCO content of 31.5±1 wt % (proportion of monomeric MDI: 43 wt %),

MDI-2: Desmodur® 44 M, 4,4′-MDI from Bayer MaterialScience AG

MDI-3: Desmodur® 44V70, polymeric MDI from Bayer MaterialScience AG, viscosity at 25° C. is 200 +/−40 mPas at an NCO content of 31.2±0.7 wt % (proportion of monomeric MDI: 30 wt %),

2,4,6-Tris(dimethylaminomethyl)phenol: from Aldrich

Benzoyl chloride: from Aldrich

POLYOL FORMULATION:
56.85 parts of POLYOL 1: sugar-started polyether based on propylene oxide, OH number: 450 mg KOH/g; MW: 650 g/mol
21.91 parts of POLYOL 2: sugar-started polyether based on propylene oxide, OH number: 440 mg KOH/g; MW: 360 g/mol
12.39 parts of POLYOL 3, trimethylolpropane-started polyether based on propylene oxide, OH number: 370 mg KOH/g, MW: 450 g/mol
3.82 parts of POLYOL 4: propylene glycol-started polyether based on propylene oxide, OH number: 112 mg KOH/g, MW: 1000 g/mol
2.24 parts of water
1.90 parts of AK-8805 polyether polysiloxane from Jiangsu May sta Chemical Co.
0.88 part of Desmorapid 726b (dimethylcyclohexylamin from Covestro Deutschland AG)
Molecular weight data (MW) reported in this invention relate to the number average molecular weight.

Measuring Procedures:
Glass transition temperature DIN EN ISO 6721-2:2008 “Plastics—Determination of Dynamic Mechanical Properties—Part 2: Torsion Pendulum Methods”
Thermal conductivity number DIN 52616:1977 “Determination of Thermal Conductivity Using a Heat-Flow Meter”
Apparent density DIN EN ISO 845:2009 “Cellular Plastics and Rubbers—Determination of Apparent Density”
Isocyanate content (NCO %) EN ISO 11909:2007 “Determination of Isocyanate Content”
Viscosity (eta) DIN EN ISO 3219:1994 “Plastics—Polymers/Resins in the Liquid State or as Emulsions or Dispersions”
Hydroxyl number (OH number): determined as per the protocol of DIN 53240 (December 1971).

Storability was assessed for the rigid PUR-PIR foams qualitatively by keeping samples in the lab at room temperature for 3 months and evaluating them visually.

The mMDI content was determined via HPLC. The HPLC analyses were carried out using an Agilent 1200 or 1260 instrument. A UV/VIS diode array detector (DAD) was used for signal recognition. The solvents used were methanol and water of HPLC quality. A linear high-pressure solvent gradient at 1 ml/min is used to improve signal separation.

### Example 1

### Preparation of Isocyanate Mixture A1 (Isocyanate Mixture Before Trimerization)

MDI-1 and MDI-2 (batch size 3 kg, weight ratio 40:60) were transferred into a 5 1 three neck flask with stirrer under nitrogen for homogenization at room temperature. Isocyanate mixture A1 from Example 1 has a viscosity of about 25 mPas at 25° C. The isocyanate mixture obtained has an overall monomeric MDI content of about 77 wt % (based on the total weight of A1) and a 4,4′-MDI content of about 75 wt % (based on the total weight of A1).

### Example 2a

### Preparation of Isocyanurate-Containing Isocyanate Blend A2

Isocyanate mixture A1 prepared in Example 1) is, under nitrogen, heated to a temperature of 60-80° C. and subjected to a trimerization reaction by catalysis of 2,4,6-tris(dimethylaminomethyl)phenol (1500 ppm). Samples of the reaction mixture are taken at intervals of about 15 minutes to determine the isocyanate content. A linear decrease in the NCO value over time under the reaction conditions allows an accurate estimation of the necessary reaction time (about 2 h) to reach the target NCO value. The reaction is stopped by admixture of benzoyl chloride (300 ppm) on reaching an isocyanate content of 26.2 wt %. The isocyanurate content (in weight percent) of isocyanate blend A2 thus obtained (isocyanurate % (A2)) is determined from the NCO decrease by the following computation:

isocyanurate % (A2)=(NCO % (A1)−NCO % (A2))/(NCO % (A1)/2)*100

The isocyanurate content of isocyanate blend A2 thus obtained is 38 wt %, the viscosity is 4250 mPas at 25° C.

### Example 2b

### Preparation of Isocyanurate-Containing Isocyanate Blend A2

Isocyanate mixture A1 prepared in Example 1) is, under nitrogen, heated to a temperature of 60-80° C. and subjected to a trimerization reaction by catalysis of 2,4,6-tris(dimethylaminomethyl)phenol (1500 ppm). Samples of the reaction mixture are taken at intervals of about 15 minutes to determine the isocyanate content. A linear decrease in the NCO value over time under the reaction conditions allows an accurate estimation of the necessary reaction time (about 1 h) to reach the target NCO value. The reaction is stopped by admixture of benzoyl chloride (300 ppm) on reaching an isocyanate content of 29 wt %. The isocyanurate content of isocyanate blend A2 thus obtained (isocyanurate % (A2)) is determined from the NCO decrease by the following computation:

isocyanurate % (A2)=(NCO % (A1)−NCO % (A2))/(NCO % (A1)/2)*100

The isocyanurate content of isocyanate blend A2 thus obtained is 21.7 wt %, the viscosity is 270 mPas at 25° C.

### Examples 3a-3h*

### Production of Rigid PUR-PIR Foams

Isocyanate component A is prepared by admixing in each case the amount reported in the table for the isocyanate blend from Example 2a with the amounts reported in the table for the isocyanates MDI-1, MDI-2 and/or MDI-3 to obtain isocyanate component A. The isocyanate component A is admixed with the POLYOL FORMULATION at an isocyanate index of 130 by addition of pentane as blowing agent, while the components used have been temperature regulated to room temperature. The amount of the blowing agent used in the examples was chosen such that the freely risen foam had approximately the same apparent densities of 28 to 30 kg/m³ and varied between 3.9 and 4.0 wt % based on the entire reaction mass, consisting of polyol formulation including added-substance materials, the isocyanate component and the physical blowing agent.

To determine their thermal conductivity number and their glass transition temperature, the foams were produced with an apparent density of about 60 kg/m³ in an aluminum mold temperature regulated to 40° C.

Examples 3-3h* reveal that the use of an isocyanurate-containing isocyanate blend A2) provides foams exhibiting distinct improvements in quality—evidenced by the glass transition temperature being increased and the thermal conductivity at the same time reduced versus Comparative Examples 3b* and 3h*. Comparative Example 3h* does not contain any pretrimerized isocyanate blend. In Comparative Examples 3d* and 3e* the isocyanurate content of isocyanate component A is too high, leading to unsatisfactory results in the storage test.

Example 3a came out particularly well in this series of tests because it leads to foams having the highest glass transition temperature and the lowest thermal conductivity number.

TABLE 1

| Example | | | | | | | |
|---|---|---|---|---|---|---|---|
| 3a | 3b* | 3c* | 3d* | 3e* | 3f | 3g | 3h* |

ISOCYANATE COMPONENT A)

| | | | | | | | | | |
|---|---|---|---|---|---|---|---|---|---|
| MDI-2 | wt % | | | 22.86 | 10.4 | 11 | | | |
| MDI-1 | wt % | 45.85 | | 15.24 | 15.9 | 5 | 23 | | 100 |
| MDI-3 | wt % | | | | | | 17 | 40 | |
| Isocyanate blend | wt % | 54.15 | | 61.9 | 73.7 | 84 | 60 | 60 | |
| A2 from Example | | | | | | | | | |
| 2a | | | | | | | | | |
| Isocyanate blend | | | 100 | | | | | | |
| A2 from Example | | | | | | | | | |
| 2b | | | | | | | | | |
| Sum total of | wt % | 100 | 100 | 100 | 100 | 100 | 100 | 100 | 100 |
| isocyanate | | | | | | | | | |
| component A | | | | | | | | | |
| Isocyanate content | wt % | 28.3 | 29 | 29.1 | 27.9 | 27.5 | 28.2 | 28.1 | 31.5 |
| Monomeric MDI | wt % | 44.5 | 56.4 | 57.2 | 50.8 | 51.7 | 42.5 | 40.0 | |
| content as per | | | | | | | | | |
| HPLC | | | | | | | | | |
| Viscosity at 25° C. | mPas | 1170 | 270 | 280 | 900 | 1200 | 1350 | 1850 | 220 |
| Polyisocyanurate | wt % | 21 | 21.7 | 21 | 27 | 30.8 | 22 | 22 | 0 |
| content | | | | | | | | | |

RIGID PUR-PIR FOAM

| | | | | | | | | | |
|---|---|---|---|---|---|---|---|---|---|
| Apparent density | kg/m³ | 61 | 59 | 60 | 61 | 60 | 61 | 61 | 62 |
| Thermal | mW/m · K | 23.30 | 24.1 | 25.3 | 24.6 | 24.30 | 24.1 | 23.6 | 25 |
| conductivity | | | | | | | | | |
| Glass transition | ° C. | >210 | 194.9 | 199.9 | 204.9 | 204.50 | 209.5 | 210 | 199 |

| | | | | | |
|---|---|---|---|---|---|
| RT storage test for | ok | inhomogeneous, partly | ok | ok | ok |
| 3 months | | crystallized | | | |

*comparative examples

### Example 4

### Production of Insulated Pipes

The components from Examples 3a and 3h were used to produce in each case composite jacketed pipes 6 m in length by the standard method using a 2K mixing and metering facility from Cannon.

The adherence of the foams to the jacketing pipe was assessed qualitatively and found to be equivalent. The axial interlaminar shear strength relative to the media pipe was measured to DIN EN ISO 253:2009. The foam from components 3a (in accordance with the present invention) had a shear strength of 0.48 MPa and that from 3h* had a shear strength of 0.45 MPa (comparative), both at a density of 65±1 kg/m³.

1. A method of producing a rigid PUR-PIR foam by reacting a PUR-PIR system comprising:
1) an isocyanate component (A) comprising:
1.1) 15-25 wt % of isocyanurate groups; and
1.2) 30-55 wt % of monomeric MDI;
1.3) an NCO content of 23-30 wt %, all based on the total weight of the isocyanate component; and
2) a polyol formulation (B);
in the presence of:
3) blowing agents (C);
4) catalysts (D); and optionally
5) further auxiliary and added-substance materials (E);
wherein the isocyanate component (A) is obtained by a method comprising:
(i) preparing an isocyanate blend (A2) by partially trimerizing an isocyanate mixture (A1) comprising oligomeric and monomeric MDI, wherein (A1) prior to trimerization comprises:
a total monomeric MDI content of 55-80 wt % based on the total weight of (A1); and
a viscosity of <30 mPas at 25° C.;
and optionally
(ii) blending the partially trimerized isocyanate blend A2 obtained in (i) with further isocyanates (A3); and
wherein the system comprising the components (A) to (E) has an isocyanate index of 90 to 150.

2. The method of producing the rigid PUR-PIR foam of claim 1, wherein the isocyanate component (A) has an isocyanurate content of 18-25 wt %.

3. The method of producing the rigid PUR-PIR foam of claim 1, wherein the isocyanate component A comprises 35-45 wt % of monomeric MDI.

4. The method of producing the rigid PUR-PIR foam of claim 1, wherein the isocyanate mixture (A) is obtained by enriching a polymeric MDI with at least one of 4,4′-MDI and TDI.

5. The method of producing the rigid PUR-PIR foam of claim 1, wherein the isocyanate mixture (A1) comprises 50-80 wt %, based on the total weight of (A1), of 4,4′-MDI.

6. The method of producing the rigid PUR-PIR foam of claim 1, wherein the isocyanate mixture (A1) prior to trimerization has a viscosity of <28 mPas.

7. The method of producing the rigid PUR-PIR foam of claim 1, wherein the system has an isocyanate index of 100 to 140.

8. The method of producing the rigid PUR-PIR foam of claim 1, wherein the monomeric MDI in the isocyanate component (A) comprises at least 80 wt % of 4,4′-diphenylmethane diisocyanate (4,4′-MDI) based on the total weight of monomeric MDI.

9. The method of producing the rigid PUR-PIR foam of claim 1, wherein the polyol formulation (B) comprises a polyetherol based on at least one of ethylene oxide and propylene oxide.

10. The rigid PUR-PIR foam obtained with the method of claim 1.

11. The rigid PUR-PIR foam of claim 10, wherein the rigid PUR-PIR foam is an insulation foam in the manufacture of composite elements.

12. A composite element comprising a rigid foam layer comprising a the rigid PUR-PIR foam produced by the method of claim 8 and at least one facing layer.

13. The composite element of claim 12 wherein the facing layer comprises at least one material selected from the group of aluminum, steel, bitumen, paper, a mineral nonwoven, a nonwoven comprising organic fibers, a polymeric panel, a polymeric film/sheet, and a wooden panel.

14. The composite element of claim 13 further comprising an insulated pipe constructed of:
a) a media pipe;
b) a layer of insulating material comprising the rigid PUR-PIR foam; and
c) a jacketing pipe.
